(19) United States
(12) Patent Application Publication
(10) Pub. No.: US 2007/0156644 A1
(43) Pub. Date: Jul. 5, 2007

(54) SQL injection detector

(75) Inventors: Jeffrey A. Johnson, Redmond, WA (US); Matthew B. Jeffries, Kirkland, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/326,234

(22) Filed: Jan. 5, 2006

(51) Int. Cl. G06F 17/30

(52) U.S. Cl. 707/2

(57) ABSTRACT

Techniques are provided for detecting injection vulnerabilities associated with a database query. An initial set of input data including one or more data items is received. A database query is in accordance with the initial set of input data. A detector determines whether one of the data items included in the initial set of input data is associated with an unexpected event by analyzing trace output generated as a result of operations executed in connection with performing the database query.

### BACKGROUND

A user may interact with an application, such as a web-based application. The application may access a database with user-supplied input data such as may be obtained, for example, in the form of a web page. The user-supplied input data may then be used in connection with querying the database. The user-supplied input data may pose a security threat in connection with information in the database if the input data is improperly filtered or unverified, and then used in formulating a query to access the database. Such unfiltered input data may be used in compromising the database, and through the database, possibly the entire system. As an example, an attacker may formulate input data which causes a subsequent database access to perform unexpected, and possibly destructive, operations. Additionally, although such operations may not result in destruction of the data included in the database, such operations may result in unauthorized operations, for example, such as allowing the attacker to view personal or other information included in the database. The foregoing may be the result of using unfiltered input data in formulating a database query resulting in injection of one or more unauthorized or unexpected database operations. It is often a difficult and tedious task to identify such security vulnerabilities with regard to injection. One technique is to try various combinations of input data and examine the resulting operations in connection with accessing the database. However, performing exhaustive testing with various combinations of input data and examining results is often cumbersome and time consuming. Additionally, existing techniques may also be error prone if performed manually by a tester since both the test data used and diagnosis of testing results may vary in accordance with the tester's skill level.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Described herein are techniques for detecting injection vulnerabilities associated with a database query. An initial set of input data including one or more data items is received. A database query is in accordance with the initial set of input data. A detector determines whether one of the data items included in the initial set of input data is associated with an unexpected event by analyzing trace output generated as a result of operations executed in connection with performing the database query.

### DESCRIPTION OF THE DRAWINGS

Features and advantages of the present invention will become more apparent from the following detailed description of exemplary embodiments thereof taken in conjunction with the accompanying drawings in which:

FIG. 1 is an example of an embodiment illustrating an environment that may be utilized in connection with the techniques described herein;

FIG. 2 is an example of components that may be included in an embodiment of a user computer for use in connection with performing the techniques described herein;

FIG. 3 is an example illustrating in more detail components from FIG. 2 that may be included in an embodiment utilizing the techniques described herein;

FIG. 4 is an example of trace output generated when executing an SQL query;

FIG. 5 is an example of a dynamic call tree and associated information from trace output;

FIG. 6 is a flowchart of processing steps that may be performed by a detector in connection with the techniques described herein;

FIG. 7 is an example representation of a processed form of the trace output;

FIG. 8 is a flowchart of processing steps that may be performed by a generator in connection with the techniques described herein; and

FIGS. 9-13 are example screenshots used in connection with illustrating the techniques described herein.

### DETAILED DESCRIPTION

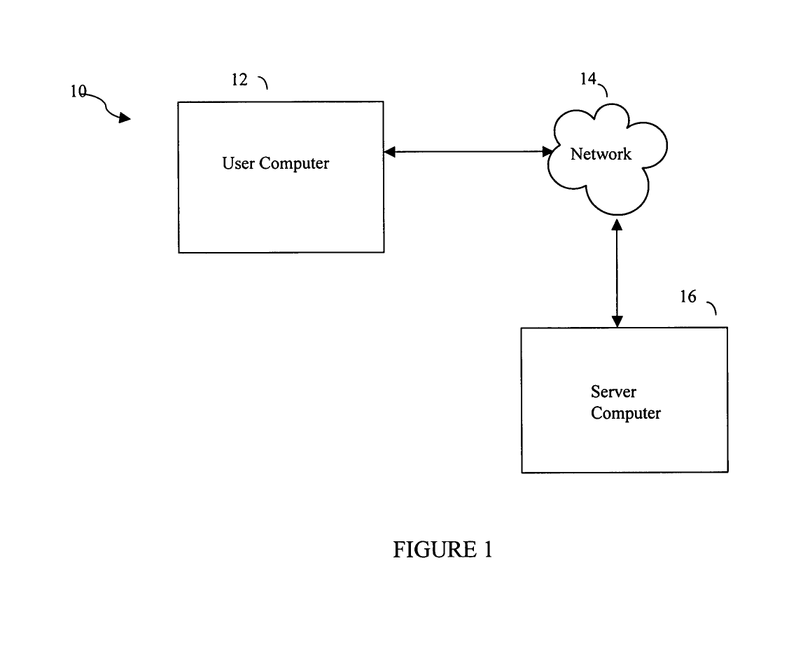

Referring now to FIG. 1, illustrated is an example of a suitable computing environment in which embodiments utilizing the techniques described herein may be implemented. The computing environment illustrated in FIG. 1 is only one example of a suitable computing environment and is not intended to suggest any limitation as to the scope of use or functionality of the techniques described herein. Those skilled in the art will appreciate that the techniques described herein may be suitable for use with other general purpose and specialized purpose computing environments and configurations. Examples of well known computing systems, environments, and/or configurations include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The techniques set forth herein may be described in the general context of computer-executable instructions, such as program modules, executed by one or more computers or other devices. Generally, program modules include routines, programs, objects, components, data structures, and the like, that perform particular tasks or implement particular abstract data types. Typically the functionality of the program modules may be combined or distributed as desired in various embodiments.

Included in FIG. 1 are a user computer 12, a network 14, and a server computer 16. The user computer 12 and server computer 16 may include a standard, commercially-available computer or a special-purpose computer that may be used to execute one or more program modules. Described in more detail elsewhere herein are program modules that may be executed by the user computer 12 and the server computer 16 in connection with facilitating detection and generation of injection vulnerabilities utilizing the techniques described herein. The user computer 12 and server computer 16 may operate in a networked environment and communicate with other computers not shown in FIG. 1.

It will be appreciated by those skilled in the art that although the user computer 12 and server computer 16 are shown in the example as communicating in a networked environment, the user computer 12 and server computer 16 may communicate with other components utilizing different communication mediums. For example, the user computer 12 and server computer 16 may communicate with each other as well as one or more components utilizing a network connection, and/or other type of link known in the art including, but not limited to, the Internet, an intranet, or other wireless and/or hardwired connection(s).

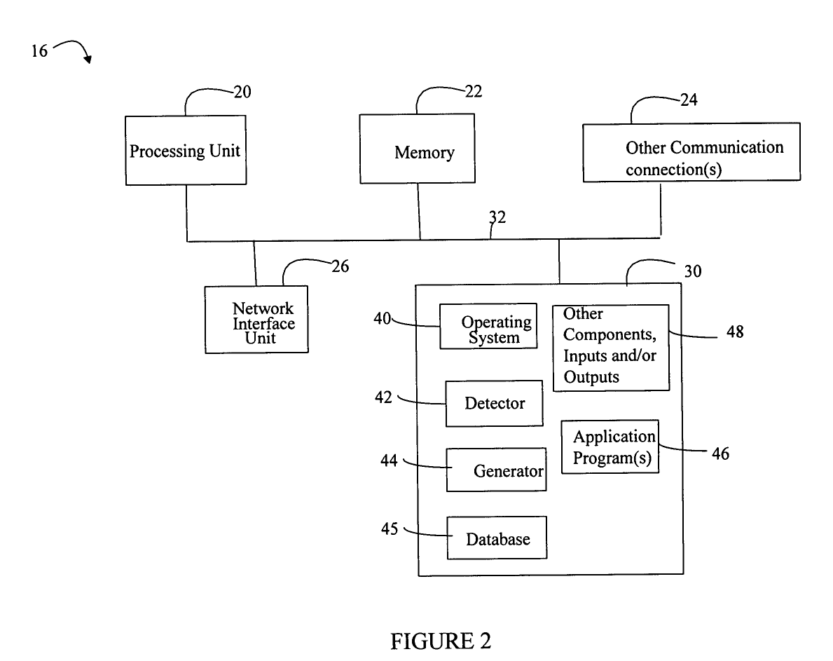

Referring now to FIG. 2, shown is an example of components that may be included in a server computer 16 as may be used in connection with performing the various embodiments of the techniques described herein. The server computer 16 may include one or more processing units 20, memory 22, a network interface unit 26, storage 30, one or more other communication connections 24, and a system bus 32 used to facilitate communications between the components of the computer 16.

Depending on the configuration and type of server computer 16, memory 22 may be volatile (such as RAM), non-volatile (such as ROM, flash memory, etc.) or some combination of the two. Additionally, the server computer 16 may also have additional features/functionality. For example, the server computer 16 may also include additional storage (removable and/or non-removable) including, but not limited to, USB devices, magnetic or optical disks, or tape. Such additional storage is illustrated in FIG. 2 by storage 30. The storage 30 of FIG. 2 may include one or more removable and non-removable storage devices having associated computer-readable media that may be utilized by the server computer 16. The storage 30 in one embodiment may be a mass-storage device with associated computer-readable media providing non-volatile storage for the server computer 16. Although the description of computer-readable media as illustrated in this example may refer to a mass storage device, such as a hard disk or CD-ROM drive, it will be appreciated by those skilled in the art that the computer-readable media can be any available media that can be accessed by the server computer 16.

By way of example, and not limitation, computer readable media may comprise computer storage media and communication media. Memory 22, as well as storage 30, are examples of computer storage media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, (DVD) or other optical storage, magnetic cassettes, magnetic tape, magnetic disk storage or other magnetic storage devices, or any other medium which can be used to store the desired information and which can accessed by server computer 16. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The server computer 16 may also contain communications connection(s) 24 that allow the server computer to communicate with other devices and components such as, by way of example, input devices and output devices. Input devices may include, for example, a keyboard, mouse, pen, voice input device, touch input device, etc. Output device(s) may include, for example, a display, speakers, printer, and the like. These and other devices are well known in the art and need not be discussed at length here. The one or more communications connection(s) 24 are an example of communication media.

In one embodiment, the server computer 16 may operate in a networked environment as illustrated in FIG. 1 using logical connections to remote computers through a network. The server computer 16 may connect to the network 14 of FIG. 1 through a network interface unit 26 connected to bus 32. The network interface unit 26 may also be utilized in connection with other types of networks and/or remote systems and components.

One or more program modules and/or data files may be included in storage 30. During operation of the server computer 16, one or more of these elements included in the storage 30 may also reside in a portion of memory 22, such as, for example, RAM for controlling the operation of the server computer 16. The example of FIG. 2 illustrates various components including an operating system 40, one or more application programs 46, a detector 42, a generator 44, a database 45, and other components, inputs and/or outputs 48. The operating system 40 may be any one of a variety of commercially available or proprietary operating system. The operating system 40, for example, may be loaded into memory in connection with controlling operation of the user computer. One or more application programs 46 may execute in the server computer 16 in connection with performing user tasks and operations. The application programs 46 may include, for example, a web application executing on the server computer 16 in connection with servicing requests as communicated from the user computer 12. The application programs 46 may also include, for example, a database application which facilitates interactions with a database 45. The detector 42 and generator 44 may perform processing steps in connection with the techniques described herein, respectively, for detection and generation of injections. An injection may occur as a result of utilizing improperly filtered or unverified input data in connection with formulating queries such as, for example, SQL queries when accessing data in the database 45. As one example, a user on the user computer 12 may input data, such as through a web form, which is then communicated to a web application executing on the server computer 16. The input data may include specially formulated data, such as by an attacker, intentionally meant to result in unauthorized database operations and/or access to data stored in the database. In one example, an attacker may be accessing a banking website which accesses a database including customer account information. A customer is first required to enter a username and password prior to accessing his/her account information. Additionally, entering a particular username and password is only meant to provide access to one set of customer information associated with the username and password rather than also allow unauthorized access to the account information of others. Consider, for example, a query which is performed for a username and password: SELECT*FROM Userdata WHERE UserName=‘input1’ AND Password=‘input2’, wherein input1 is the specified username and input2 is a password input which always evaluates to true, such as ‘OR’1=’1. The attacker may input data such as information for the foregoing password which is nonsensical but always true. Entering such password data may cause problems when formulating the database query. For example, such a password may cause checking for a matching password for the specified name to always evaluate to true providing the attacker access to any customer account. In the foregoing example, the resulting query which is executed may be: SELECT*FROM UserData WHERE UserName=‘input1 AND Password=“OR‘1’=‘1’.

The foregoing is one example of the type of input data that may be injected into the formulated query characterizing an injection vulnerability. In examples used herein, the underlying database query language may be, for example, SQL although other query languages may also used in connection with the techniques described herein in systems having injection vulnerabilities.

Existing systems and techniques may be characterized as cumbersome and tedious in order to determine if a particular feature in an application is vulnerable to an injection attack. It is generally a time consuming process to probe each value with a variety of different inputs to determine if any unexpected behavior results. The techniques described herein, utilizing the generator and the detector, may be used to automatically generate different input values for one or more elements of a query language statement and determine when an SQL injection appears to have occurred.

The techniques described herein may be used in connection with generating and detecting SQL, or other query language, injection vulnerabilities caused by insufficient filtering of input data. The techniques described herein, for example, may be used in detecting which input data (e.g., password=‘1=1’) is associated with an injection vulnerability, as well as generating various input data to be used in connection with testing for injection vulnerabilities. The generator 44, as will be described in more detail, may be used in connection with generating various input data in order to test for injection vulnerabilities. The detector 42, as will also be described in more detail, may be used in connection with detecting an injection vulnerability and identifying the particular input data associated with the injection vulnerability. The detector 42 and the generator 44 may be used in combination in an embodiment as will be described in following paragraphs. However, as will be appreciated by those skilled in the art, the detector 42 and the generator 44 may also be used without the other in an embodiment.

It should be noted that the input data associated with the injection vulnerability may actually include additional SQL commands to, for example, retrieve data, delete information, and the like. Such injection vulnerabilities may occur when an attacker includes complete SQL statements, for example, within single quotes (′). Data validation of such portions of the input data, such as within the single quotes, may be omitted or otherwise incomplete so that the attacker's input data is included unmodified in the formulated query resulting in an injection vulnerability.

It should also be noted that although the application used in the example described herein is a web application, the techniques described herein may be used in connection with other types of application obtaining input data from a variety of different input sources.

An injection may occur, for example, as the result of malicious data of an attacker as described above. It should be noted that although an injection may be the result of malicious intentions, an injection may also occur as a result of an innocently malformed set of input data.

The user computer 12 may include various combinations of components as illustrated in connection with FIG. 2 for the server computer 16. The user computer 12 may however include different components in the storage 30 that may vary with the different operations performed by the computer 12. The server computer 16 may represent one or more computers, each including single or multiple CPUs, in order to handle the incoming traffic, such as needed to interact with one or more user computers 12. Some of the components that may be included in an embodiment of a user computer 12 and used in connection with the techniques described herein are illustrated in more detail in other figures.

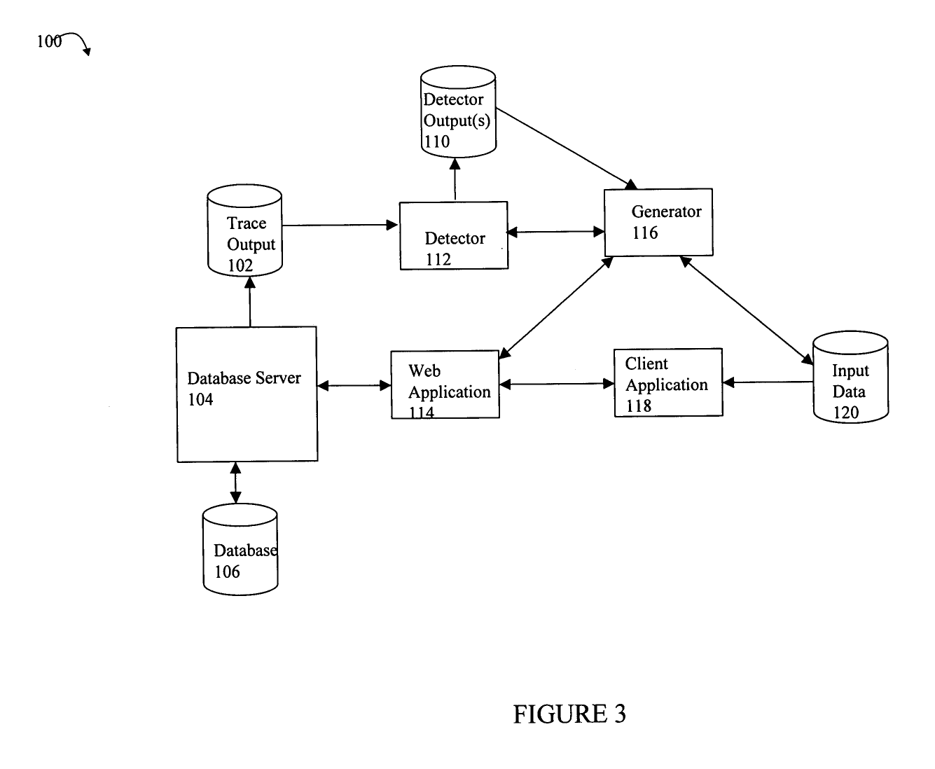

Referring now to FIG. 3, shown is an example illustrating in more detail components from FIG. 2 that may be included in an embodiment utilizing the techniques described herein. Additionally, FIG. 3 includes some components that may be included in an embodiment of a user computer 12. This is described in more detail elsewhere herein. The example 100 includes trace output 102, a database server 104, a database 106, detector output 110, detector 112, web application 114, generator 116, client application 118 and input data 120. In this example, a user may input data 120 using a web form with a client application 118, such as a Web browser, executing on the user computer 12. In normal operation, the input data 120 may be obtained utilizing the client application 118. For example, input data may be obtained using a web form displayed by a browser application. The input data 120 may then be communicated to a web application 114, as may be executing on the server computer 16. The web application 114 may communicate with the database server 104 to access the database 106. As described elsewhere herein, one or more pieces of input data 120 may be used in connection with formulating a query to access data in the database 106.

The generator 116, detector 112, trace output 102, and detector output 110 may be used in connection with the techniques described herein for automatic generation of input data generation and detection of SQL injection vulnerabilities. The techniques described herein may be used in facilitating determination of injection vulnerabilities. The detector 112 monitors the results of executing SQL statements and indicates when an SQL injection may have occurred. The generator 116 supplies values that may be used in constructing the SQL statements when testing for SQL injections. In one application, the components 102, 110, 112 and 116 may operate in a testing or non-production embodiment in order to exercise the web application 114 and other components as may be used in a production environment in order to test for existing injection vulnerabilities. The techniques described herein may be used, for example, by a developer or tester of the web application or other components utilized in connection therewith.

In one embodiment, the generator 116 may intercept, or otherwise monitor, input data 120 as may be input by a user. A first initial set of data may be manually entered. The generator 116 may then use this initial set of data to generate additional sets of test data as described in more detail in following paragraphs. The initial set of data may be communicated to the web application 114 and used in connection with formulating one or more SQL statements which are executed by the database server 104. The database server in this example utilizes SQL although other embodiments may use other database languages and statements in connection with the techniques described herein. In this embodiment, the database server 104 may be enabled to output trace output 102. As known in the art, trace output may be produced as a result of executing SQL procedures, statements, and the like. The database server 104 produces trace output 102 in accordance with what SQL statements, procedures, and the like, are executed. The SQL statements, procedures, and the like, may use one or more items of input data 120.

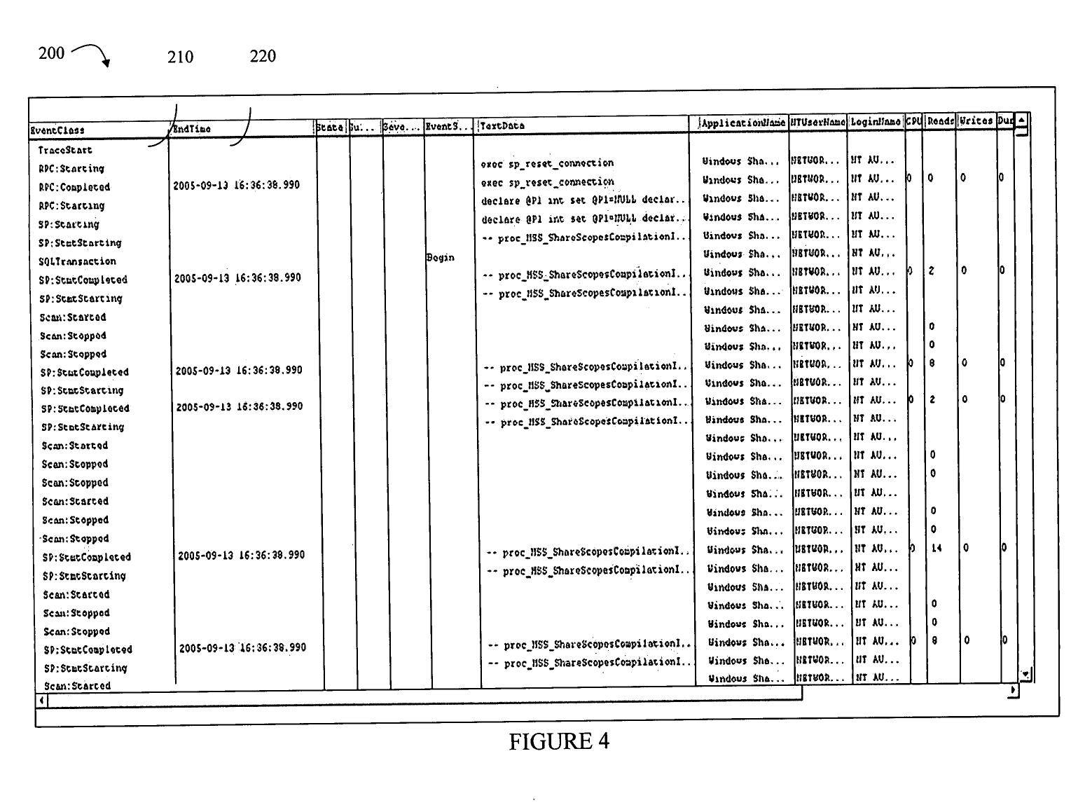

Referring now to FIG. 4, shown is an example representation 200 of data as may be included in trace output 102. The example 200 includes information about events that occurred when the database server 104 was executing SQL statements. The example 200 is in tabular form with a row for each event detected. The information includes, for example, a particular class of event as indicated in column 210, an associated end time 220 for the event (if applicable), and other data in other columns. This data included in 200 is output as the events are detected during execution. As illustrated, the trace output 102 in the representation 200 may include information about remote procedure calls and other statements and functions executed. It should be noted that a user may select which events and other aspects have corresponding trace output data generated by the database server 104. Additionally, the particular information recorded in the trace output as represented in 200 may vary with embodiment. A user may also select which particular information is to be output for each event thereby affecting the information as included in each row of data for each event.

One job of the detector 112 is to parse the trace output 102, which may be characterized as an ordered list of events resulting from SQL operations performed, and generate one or more usable forms of information included in the detector output 110 for use in connection with the techniques described herein. In one embodiment, the detector 112 parses the trace output 102 and generates a dynamic call tree. As known to those skilled in the art, a dynamic call tree may be characterized as an ordered list of calls made at a particular point in runtime. A dynamic call tree may be characterized as representing a snapshot of which routine calls are active at a particular point in time. In this embodiment, the call tree may include a list of database calls including remote procedure calls and stored procedure calls. Each of the procedure calls may perform one or more statements as well as make other procedure calls. The data included in the trace output 102 may include a process or thread identifier associated with a calling routine, a timestamp associated with when a call is made, and the parameter data used in connection with the call. The detector 112 may parse the trace output 102 to extract records for calls of interest and order these calls in accordance with the associated timestamp.

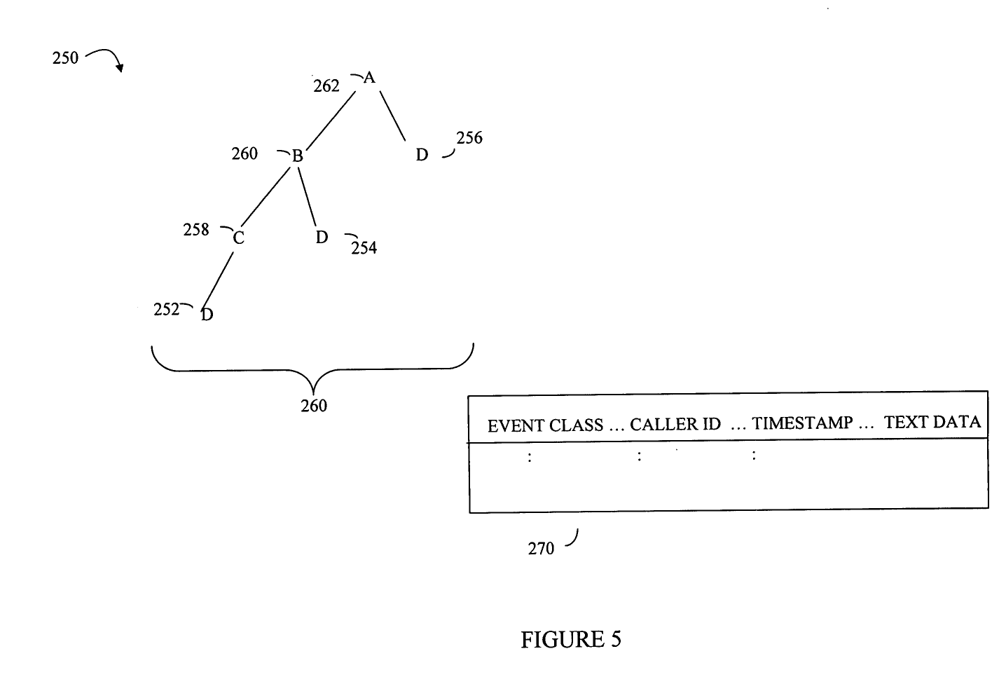

Referring now to FIG. 5, shown is an example representation of a dynamic call tree 260 as may be represented by selected data items of records of interest 270 included in the trace output 102. The example 260 may represent a snapshot of active runtime calls at a point in time while executing one or more SQL calls and statements. The detector 112 may parse the trace output 102 for records including the event types or classes of interest (EVENT CLASS), such as remote procedure calls (RPC) and stored procedure calls. The associated CALLER ID identifies the calling procedure or routine and the TIMESTAMP may be used to indicate an ordering of calls made at different points in time by a same calling procedure or routine. The TEXTDATA field may include information identifying the called routine and the various input data communicated in that particular call. Using the foregoing information, the detector 112 may store selected portions of the trace output 102 which graphically represent, for example, the dynamic call tree 260. In the example 260, each node in the tree represents a routine or procedure invocation. The root of the tree is A and represents the first or starting invocation. Subsequently, additional invocations made by a node are represented by children at the next lower level. For example, A has two invocations as represented by nodes 260 and 256. Node 260, B, also has two invocations as represented by nodes 254 and 258. Node 258, C, also has an invocation as represented by node 252. The foregoing illustration 250 represents one execution snapshot of active routine or procedure invocations at one point during runtime.

During runtime when executing a procedure call or a statement within a procedure, an exception may occur. The exception that occurs has a corresponding record in the trace output 102 that may include a type of EVENT CLASS identifying the exception as well as other information regarding the exception. The other information may include a TIMESTAMP identifying when the exception occurred and TEXT DATA identifying the relevant input data associated with the exception. The TIMESTAMP may be used in connection with identifying when a particular call was made by a calling routine. The detector 112 may be executing as a task which performs processing when trace output is generated. The detector 112 may, for example, perform polling to monitor when the trace output 102 is generated. Other embodiments may use other techniques in connection with invoking the detector 112. For example, an embodiment may also provide for notification to the detector 112 when trace output is generated. Other embodiments may use other techniques in connection with invoking or triggering the detector's operation.

In operation with reference to FIG. 3, the web application 114 and database server 104 are executing and the user may input data 120 using the client application 118's interface. The trace output 102 may be generated every time the user inputs a set of data causing the detector to execute. The generator 116 may initially start the detector process.

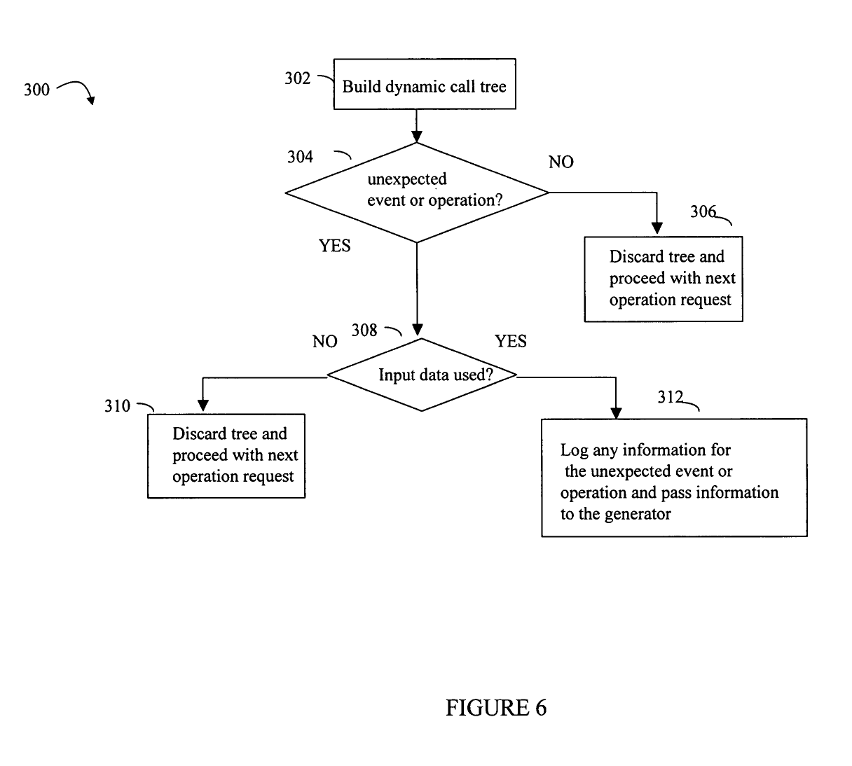

Referring now to FIG. 6, shown is a flowchart 300 of processing steps that may be performed by the detector utilizing the generated trace output 102. The processing steps of flowchart 300 include a summary of detector processing just described. At step 302, the trace output 102 is parsed to build the dynamic call tree. At step 304, a determination is made as to whether an unexpected event or operation has occurred as determined by the detector 112. An unexpected event or operation may include, for example, execution of an SQL statement raising an exception, error, and the like. Additionally, an embodiment may also consider execution of certain unexpected statements without raising an exception or error as indications of SQL injections. The detector may have a list of one or more operations, statements, and the like, which may be characterized as unexpected such as, for example, creation of a new table, deletion of an entire table, and the like. The occurrence of one of these unexpected operations, statements, or an exception, error, and the like, may cause step 304 to evaluate to yes. If step 304 evaluates to no, the tree is discarded and processing continues with the next set of generated trace output associated with the next operation request. If step 304 evaluates to yes, control proceeds to step 308 where it is determined if input data is used in connection with the unexpected event or operation identified at step 304. A determination of whether input data is used may be made, for example, by examining the TEXTDATA field of the record associated with the unexpected event or operation. If input data is not used, control proceeds to step 310 where the tree may be discarded and control may proceed to wait for the next operation request. Otherwise, if step 308 evaluates to yes, control proceeds to step 312. At step 312, information may be optionally logged regarding the unexpected event or operation. This information may include, for example, data from the trace output, or based thereon such as the current call path, the statement or operation causing the exception, associated input data, and the like. The information passed to the generator 116 may include information used by the generator 116 in generating subsequent input data as will be described in following paragraphs. This information communicated to the generator 116 may include identification of the particular event or operation that was unexpected, associated input data, location of input data (e.g., parameter positions), and the like.

It should be noted that an embodiment of the detector 116 may determine whether there are unexpected events or operations while parsing the trace output as part of generating the dynamic call tree. In other words, an embodiment of the detector 116 may read a record from the trace output 102 while building the call tree and may also examine this record to see if there is an unexpected event or exception. As will be appreciated by those skilled in the art, the processing steps of flowchart 300 of FIG. 6 may be readily modified for use in such an embodiment.

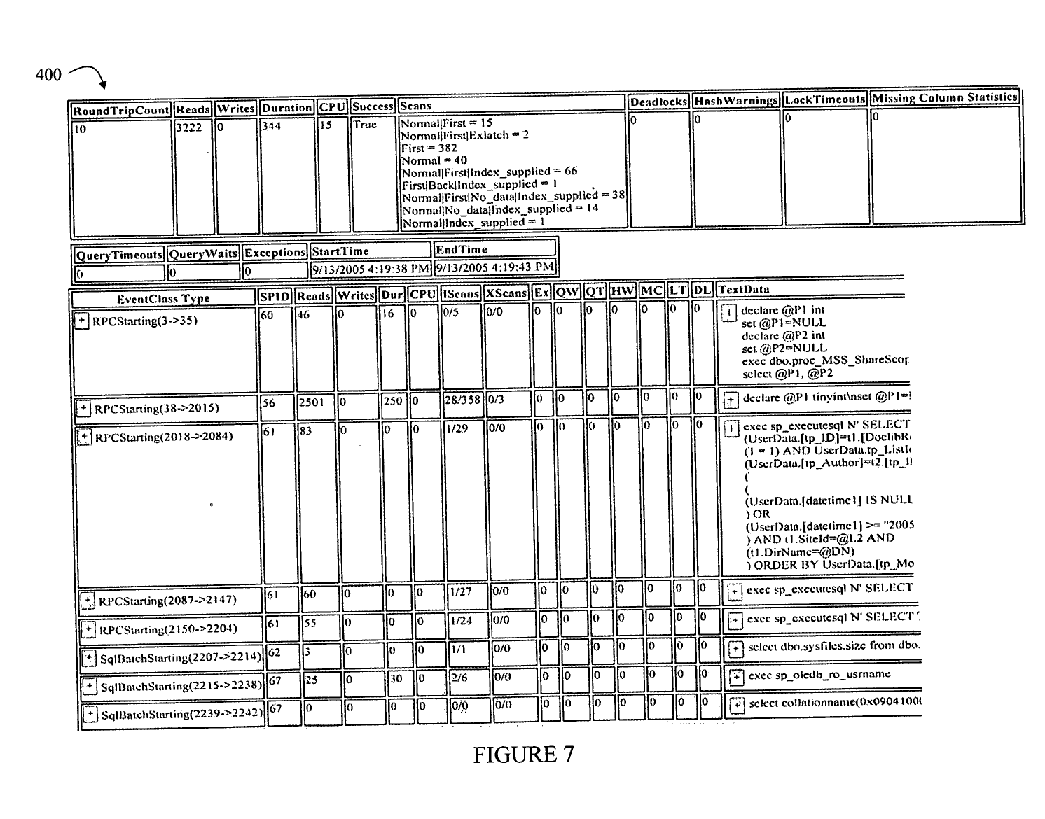

The detector 112 may also produce as a detector output 110 information extracted from the trace output 102 and organized into a form for viewing or display. In other words, the raw trace output 102 may be voluminous and cumbersome to use. The detector 112 may reorganize the information into a form which facilitates easier comprehension and viewing. FIG. 7 includes an example of a representation 400 of such information in what may be characterized as a “rolled up” form of the trace output data, for example, as illustrated in 200 of FIG. 4.

The dynamic call information may be used in connection with facilitating identification of a location associated with an SQL injection vulnerability. The location of the unexpected event or operation may be further identified via a dynamic call path as may be identified in accordance with the dynamic call tree information. Such dynamic call information may used in identifying problems associated with nested procedure calls. The unexpected event or operation may have an associated call path identifying the active call chain of routines. For example, with reference to 260 of FIG. 5, an exception may occur when executing routine D. However, as illustrated in 260, there may be multiple instances of a routine D in progress at a point in time. In order to further identify which instance of routine D (e.g., 252, 254 or 256) is associated with the exception, the dynamic call path associated with each instance of D may be used. For example, the dynamic call path associated with 252 is A(262)-B(260)-C(258)-D(252). Such information may be used in tracking down the injection and identifying related problems in testing.

It should be noted that some of the processing described as being performed by the detector may also be performed by the generator. In other words, an embodiment may vary the partitioning of tasks performed by the detector and generator. For example, in one embodiment, the detector may report exceptions associated with input data to the generator along with any other relevant information such as the call path, associated input data items, location of input data in a statement or call, and the like, as described elsewhere herein. The detector may produce a parsed version of the trace output such as represented in 400 of FIG. 7, to the generator as well. The generator may then perform processing associated with determining unexpected events which did not cause an exception. In other words, for all possible unexpected events or operations that may indicate and SQL injection, the detector may report to the generator on those causing exceptions and the generator may examine the parsed trace output for those unexpected events that did not cause exceptions. Examples of such unexpected events not causing exceptions may include deletion of an entire table, creation of a new table, accessing a particular data file, and other statements or operations. The foregoing may be characterized as unauthorized operations that, although may be successful, should not be occurring for the particular application. The generator, rather than the detector, may further perform the processing to determine if the input data is associated with the reported exception.

It should be noted that an exception as reported by the detector may be caused by an SQL injection vulnerability or other problem. An embodiment may or may not be able to further refine by information in the trace output the cause for a particular exception.

The generator 116 may be used to generate input data used to test for SQL injection vulnerabilities. In one embodiment, the generator 116 may obtain an initial set of input data as identified by the detector as being associated with an unexpected event or operation. Using this initial set of input data along with the additional information that may be passed by the detector to the generator, one or more subsequent sets of input data may be generated to further testing. The generator 116 may obtain the initial set of input data by intercepting the input data 120 as input by a user. Depending upon the results as reported by the detector, the generator 116 may further manipulate the input data producing subsequent sets of input data for testing.

Using the initial set of data, the generator 116 produces input data used in subsequently executed SQL statements, procedures, and the like. In one embodiment, the generator 116 may manipulate a first data item to produce one or more permutations each of which may be used as a subsequent input data. The one or more permutations may be a predefined set of instructions which are applied to the first data item or previous permutations. The generator will loop through each of these permutations and supply each as the user-supplied input data 120 in an attempt to create further unexpected events or operations indicating an SQL injection vulnerability.

The number of permutations may be configurable in order to allow for adaptation and modifications in accordance with new malicious strings that are found to cause an SQL injection vulnerability.

The particular set of permutations applied to a given data item may vary in accordance with one or more of attributes of the data item as well as the use context associated with the data item. For example, the set of permutations applied may be determined in accordance with a data type of the data item (e.g., numeric, string, within quotations), location and usage within the offending in SQL statement or procedure (e.g, value for a particular field, command, etc.), and the like. The generator may continue to apply the next defined permutation to a data item in generating subsequent sets of input data until one of two conditions occurs: all predefined permutation have been applied, or an unexpected event or operation occurs.

In a given set of input data, there may also be one or more data items. The generator may change one or more of the data items at a time in producing subsequent sets of data. The particular permutations may be based on experience of what known types of data, statements, parameters, and other characteristics are known to be sources of vulnerabilities.

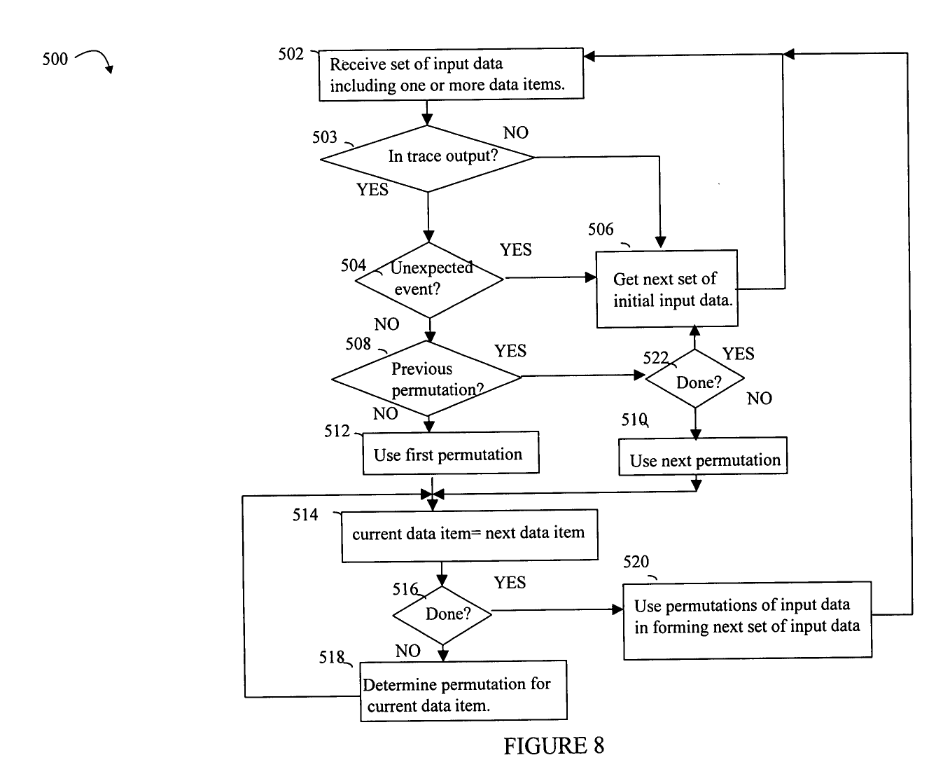

Referring now to FIG. 8, shown is a flowchart of processing steps that may be performed in an embodiment of the generator in connection with generating input data. The processing of the flowchart 500 of FIG. 8 summarizes processing steps just described above in connection with generating input data. At step 502, a set of input data is received. The set of input data may include one or more data items. The input data may be the initial set of input data as intercepted by the generator. The remaining processing steps of flowchart 500 may be performed, for example, once the detector has completed its processing and generates the detector outputs as may be communicated to the generator. At step 503, a determination is made as to whether one or more of the input data items included in the received input data set are included in the trace output. The generator may determine this by parsing through the condensed form of the trace output as received from the detector. Recall that this may be as represented, for example, in connection with FIG. 7. If step 503 evaluates to no, control proceeds to step 506 to get another set of input data. Recall that not all input data may actually be used in SQL statements. If the input data is not utilized in connection with an SQL statement, procedure, and the like, the generator ignores the input data. If step 503 evaluates to yes, control proceeds to step 504. At step 504, a determination is made as to whether the input data is associated with an unexpected event. If step 504 evaluates to yes, processing proceeds to step 506 to obtain a next set of new input data. In such instances where there is an unexpected event, the generator obtains a new initial set of input data used for generation because the current input data set is considered to be in an end state. From step 506, control proceeds to step 502. If step 504 evaluates to no, control proceeds to step 508 where a determination is made as to whether the received set of input data includes previous permutations (i.e., is a permuted input set). A permuted input set may be characterized as an input data set including one or more data items formed as a result of one or more permutations by the generator. In other words, the permuted input set includes at least a portion of input data previously produced by the generator. If step 508 evaluates to yes, control proceeds to step 522 to determine if all of the permutations included in a predefined set of permutations have been applied for any one data item included in the input set. If so, control proceeds to step 506 to obtain a new set of input data. Otherwise, if step 522, of evaluates to no, control proceeds to step 510 to use the next set of instructions for the next permutation. Control then proceeds to step 514.

It should be noted that an embodiment may define permutations for single data items. It is possible for one set of permutations to be defined for a first data item which includes more permutations than a second set of defined permutations for a second data item. In such cases, an embodiment may decide to obtain a new initial set of input data for subsequent input data generation when any one of the data items has reached an end state. The foregoing describes a second type of end state associated with input data in which all defined permutations have been tested. It should be noted that other embodiments may perform other processing than as described herein in connection with such cases. If step 508 evaluates to no, control proceeds to step 512 where the first permutation for the current data item is determined. Control then proceeds to step 514.

At step 514, the current data item is assigned to be the next data item in the input data received at step 502. Control proceeds to step 516 where determination is made as to whether all of the data items included in the input data set received have been processed. If so, control proceeds to step 520 to use the current permutations of the received input data in forming the next set of input data sent to the web application. From step 520, control proceeds to step 502. If step 516 of evaluates to no, control proceeds to step 518 to determine the next permutation for the current data item. Control then proceeds to step 514 to continue to produce permutations for remaining data items in the received input data set.

It should be noted that the generator may form permutations of one or more data items included in the input data set. In other words, the generator may, in accordance with one or more aspects of the input data set, apply permutation rules to only a portion of the input data items therein. For example, if only a portion of the input data items are included in the trace output, the generator may only modify those input data items. The generator may also only modify a portion of the input data items in the input data set in accordance with the context of the input data items. For example, the generator may form permutations for data items associated with certain SQL statements, parameters, and the like, known for SQL injection vulnerabilities. The permutations may, for example, manipulate previous or original data items in accordance with a set of predefined rules.

It should be noted that the input data generated may be used in connection with performing testing at different levels with respect to the components of FIG. 3. The generated data, for example, maybe input to the client application 118. In order to perform sufficient testing, the generated data may also be used in connection with other configurations. For example, the input data may be supplied by the generator directly to the web application rather than through the client application. It may be desirable to test supplying input data through a variety of different configurations because an attacker may similarly supply input data in any one of the different configurations. The particular configurations and levels at which input data is supplied in connection with testing may vary in accordance with each embodiment.

To further illustrate the techniques described herein, an example will now be described in connection with several figures.

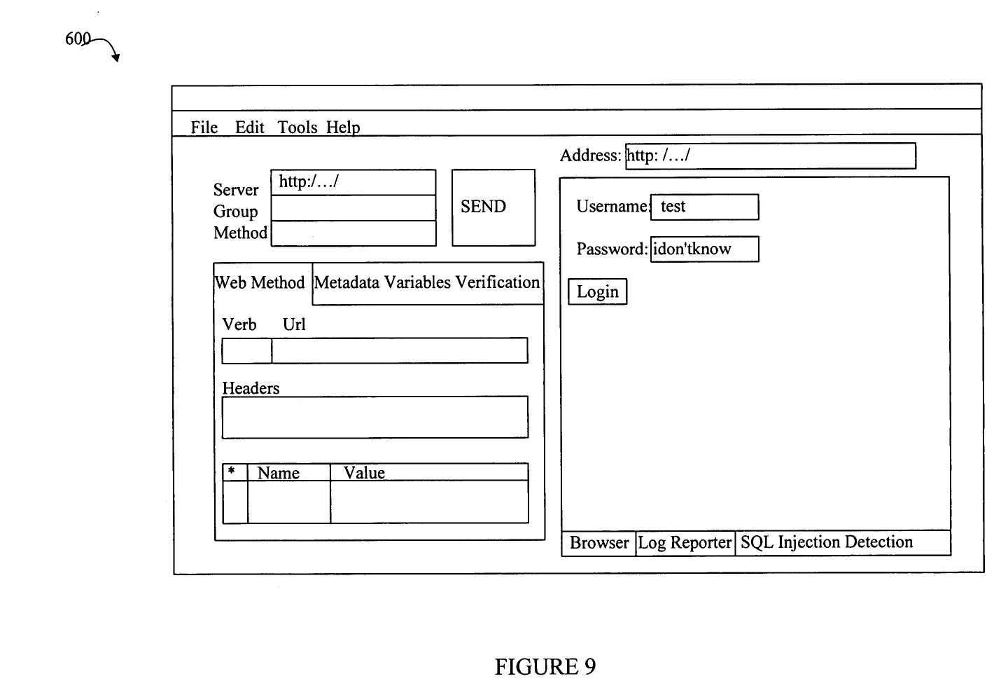

Referring now to FIG. 9, shown is an example of a screenshot 600 as may be displayed in connection with a login page. The example will illustrate use of the foregoing login page in connection with constructing an SQL query to determine if the user and associated password are valid. FIG. 9 shows the login page viewed. In this example, input data may be entered manually on the login page, or supplied by the generator for automated testing. Recall that, as described herein, an embodiment may also utilize the detector without the generator in a mode in which the detector is executed and input data is manually entered. When the generator is used, the data source comes from the generator rather than via manual entry.

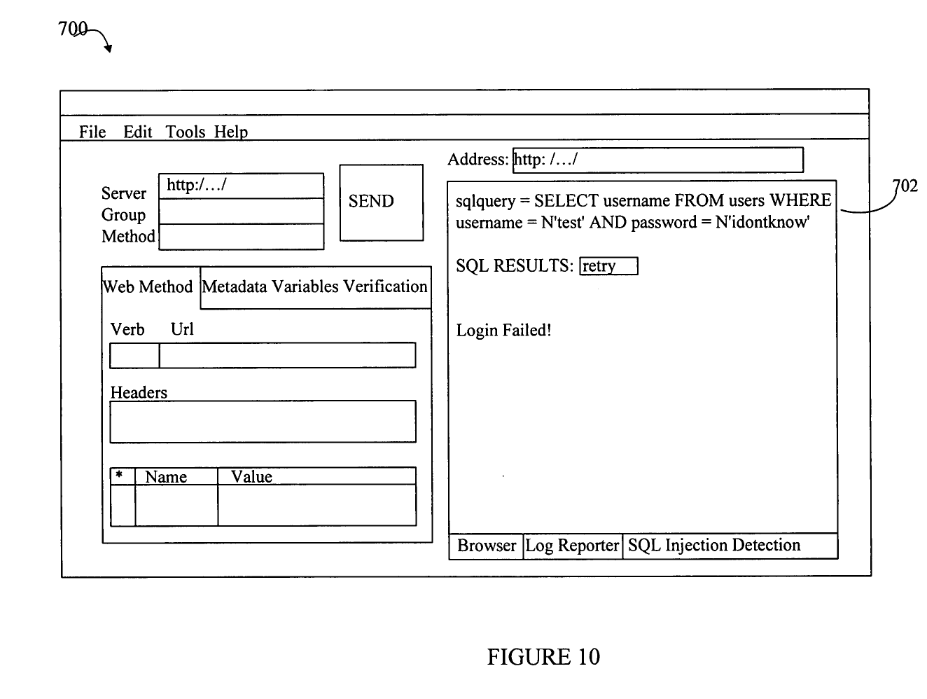

Referring now to FIG. 10, shown is an example of a screenshot 700 as may be displayed when a user tries to logon with a username and password. In this example, the user supplied input data is username of “test” and password of “idontknow”. The example 700 shows the generated SQL query based on the supplied user input data. Of course, the users would not see the SQL query, but the information included in 702 is what is further transformed into one or more SQL statements, procedure calls, and the like (as will be described in following paragraphs), and illustrates what parameters include the user input data. The example 700 may illustrate how input data may be obtained using a web form, for example, used with a software Web browser. As described above for adequate testing, data may also be input directly to the web application. The browser may, for example, perform some filtering of the input data. It may be desirable to also test the input data being input directly to the web application.

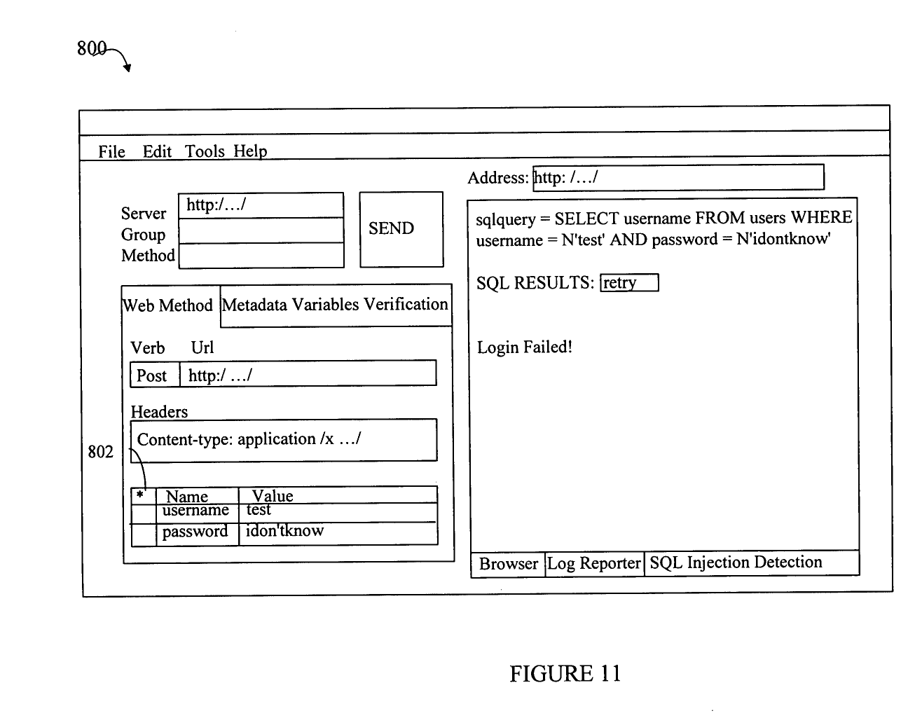

FIG. 11 illustrates another screenshot 800 in which the same input data is sent directly to the web application. In the example 800, the input data being communicated directly to the web application is included in 802. The screenshot 800 may be displayed as an interface for obtaining user input data in area 802 which is then sent to the web application.

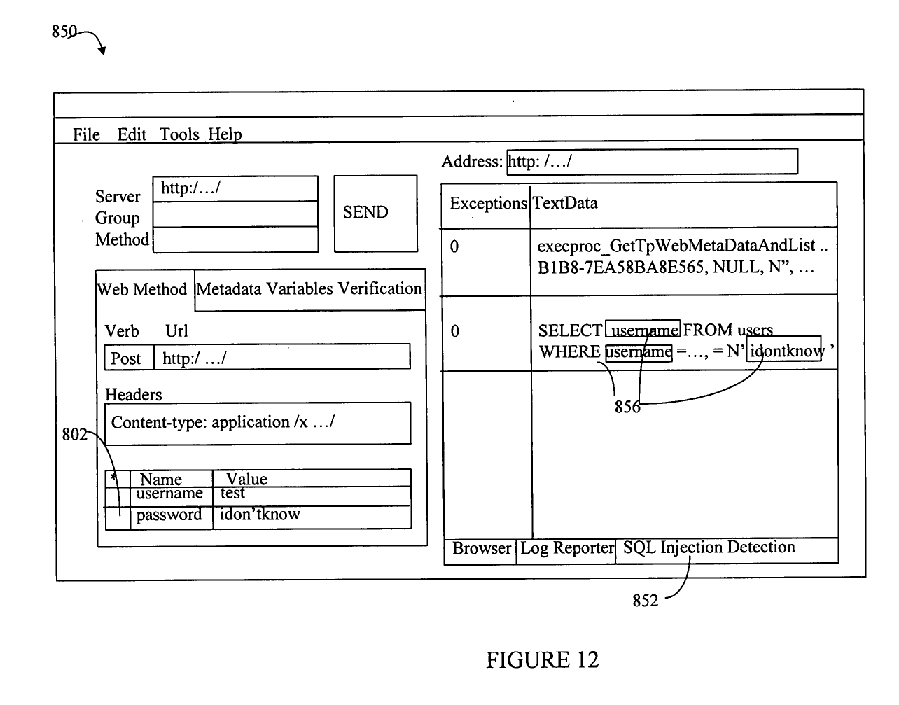

Referring now to FIG. 12, shown is a screenshot 800 illustrating the SQL statements corresponding to the previous query. The SQL statements are included in area 854. In this example, the tab 852 indicates that the display is configured to display the actual SQL statement(s), procedure calls, and the like corresponding to the query. The information included in 854 may be included in the parse detector output 110, such as previously illustrated in FIG. 7 and described elsewhere herein in more detail. Note that user input data is illustrated as 856. In this example, no exceptions are caused so the detector reports no exceptions for the given set of input data. The detector may also communicate sufficient additional information to the generator so the generator may attempt to generate subsequent sets of input data to see if permutations of the original input data may generate an injection. The additional information communicated to the generator may include, for example, the particular statement (e.g., Select statement) and parameters and identifying which parameters included the user input data. Such information may be included in the parse detector output as illustrated in FIG. 7.

The generator may now generate additional input data for the username and/or password. In this next example, the generator generates input data for the password and uses the same previous username value. The generator may only form permutations for the second data item, the password, since it may be known that variations of the password may cause SQL injections.

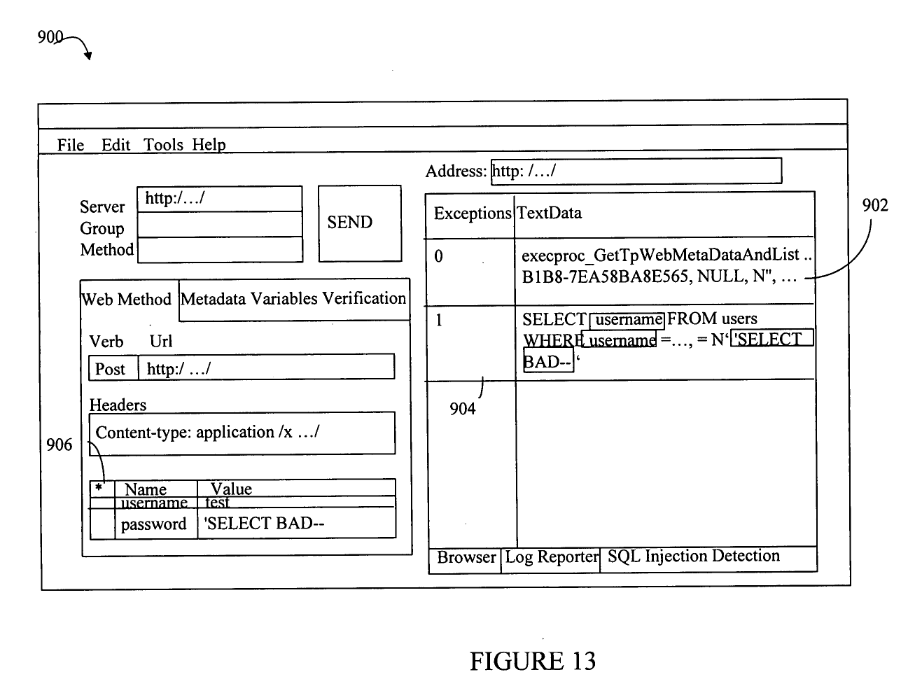

Referring now to FIG. 13, shown is an example of a screenshot 900 used in connection with communicating a next set of input data to the web application. The input data is included in area 906 and includes a new password as a string ‘SELECT BAD--’ which causes an SQL injection as illustrated by the “1” in the exceptions column 904. By sending the web application different values for the password, the generator may attempt to cause a SQL injection bug. The generator may provide permutations of one or more data items included in a set of input data. The permutations as described herein may be crafted SQL statements to attempt to cause an injection. The data sent back by the detector in this instance notifies the generator that an injection occurred. In this example with the screenshot, the exception is reported via the user interface screenshot. However, in the automated case, the detector and/or generator may log the exception failure and processing may continue. Which component logs the failure may vary in accordance with the partitioning of tasks in an embodiment, as also described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for detecting injection vulnerabilities associated with a database query comprising:
receiving an initial set of input data including one or more data items;
issuing a database query in accordance with said initial set of input data; and
determining, by a detector, whether one of said data items included in said initial set of input data is associated with an unexpected event by analyzing trace output generated as a result of operations executed in connection with performing said database query.

2. The method of claim 1, further comprising:
generating a first output including execution information associated with one or more operations performed when executing said database query.

3. The method of claim 2, wherein said detector parses said trace output in connection with performing said determining step.

4. The method of claim 1, wherein said unexpected event is a runtime exception error.

5. The method of claim 2, wherein said detector produces a processed form of said trace output.

6. The method of claim 5, wherein said processed form is used by a generator in generating a subsequent set of input data by forming a first permutation of at least one of said data items from said initial set of input data included in said processed form.

7. The method of claim 1, further comprising:
forming, by a generator, a subsequent set of input data including a permutation of at least one of said data items from said initial set of input data.

8. The method of claim 7, wherein said generator only forms permutations of data items utilized in connection with said database query.

9. The method of claim 7, wherein said generator utilizes a predefined set of instructions in forming permutations.

10. The method of claim 9, wherein at least one of said permutations are formed in accordance with a data type of said data item.

11. The method of claim 9, wherein at least one of said permutations are formed in accordance with a usage context associated with a data item.

12. The method of claim 11, wherein said usage context includes use of said data item as a value for a parameter in connection with a particular database command.

13. The method of claim 11, wherein said usage context includes use of said data item as a value for a parameter in connection with a procedure call.

14. The method of claim 1, wherein said detector uses said trace output in determining a dynamic call tree representing runtime calls at a first execution time.

15. The method of claim 1, wherein said unexpected event is an unexpected database operation that does not cause a runtime error.

16. A computer readable medium having computer executable instructions stored thereon for performing steps for detecting injection vulnerabilities associated with a database query, the steps comprising:
receiving an initial set of input data including one or more data items;
issuing a database query in accordance with said initial set of input data;
generating trace output including execution information for operations performed in connection with executing said database query;
determining, by a detector using said trace output, whether one of said data items included in said initial set of input data is associated with an unexpected event; and
generating, using a generator, a subsequent set of input data used in connection with a second database query, said generator forming at least one data item in said subsequent set using at least one data item from said initial set if said initial set did not cause an unexpected event and said at least one data item in said initial set is utilized in connection with said database query.

17. The computer readable medium of claim 16, further comprising computer executable instructions stored thereon for performing the steps of:
determining whether said at least one data item in said initial set is utilized in connection with said database query by examining said trace output to determine if said at least on data item is included therein.

18. The computer readable medium of claim 17, further comprising computer executable instructions stored thereon for performing the steps of:
forming a data item in said subsequent set by manipulating a data item from said initial set in accordance with a set of predefined rules.

19. A computer readable medium for detecting injection vulnerabilities associated with a database query having computer-executable components stored thereon, comprising:
an interface that receives an initial set of input data including one or more data items;
a database that generates trace output including execution information for operations performed in connection with executing said database query;
a detector that determines, using said trace output, whether one of said data items included in said initial set of input data are associated with an unexpected event; and
a generator that generates a subsequent set of input data used in connection with a second database query, said generator forming at least one data item in said subsequent set using at least one data item from said initial set if said initial set did not cause an unexpected event and said at least one data item in said initial set is utilized in connection with said database query.

20. The computer-readable medium of claim 19, wherein said generator determining whether said at least one data item in said initial set is utilized in connection with said database query by examining said trace output to determine if said at least on data item is included therein.
